(19) United States
(12) Patent Application Publication
(10) Pub. No.: US 2024/0367353 A1
(43) Pub. Date: Nov. 7, 2024

(54) ENVIRONMENTALLY FRIENDLY FOAMING MATERIAL BASED ON EVA WASTE MATERIALS AND TREATMENT METHOD FOR EVA WASTE MATERIALS

(71) Applicant: Maotai (Fujian) New Material Technology Co., Ltd., Jinjiang City (CN)

(72) Inventors: Xin LU, Jinjiang City (CN); Yibin LIAO, Jinjiang City (CN); Yuling WANG, Jinjiang City (CN); Zhijie LIN, Jinjiang City (CN); Sibo DING, Jinjiang City (CN); Sien DING, Jinjiang City (CN); Chunshu XU, Jinjiang City (CN); Xiuzhi LIN, Jinjiang City (CN); Xueling DAI, Jinjiang City (CN); Rongda ZHENG, Jinjiang City (CN)

(21) Appl. No.: 18/776,038

(22) Filed: Jul. 17, 2024

Related U.S. Application Data
(63) Continuation of application No. PCT/CN2022/114521, filed on Aug. 24, 2022.

(30) Foreign Application Priority Data
Jan. 17, 2022 (CN) 202210048974.1

(51) Int. Cl. B29B 17/04; B29C 48/00; B29C 48/08; B29K 23/00; B29K 105/04; B29K 105/26; C08J 9/00; C08J 9/10; C08J 11/06

(52) U.S. Cl. CPC B29B 17/0412; B29C 48/022; B29C 48/08; C08J 9/0061; C08J 9/103; C08J 11/06; B29B 2017/0476; B29B 2017/0484; B29C 2948/92704; B29K 2023/083; B29K 2105/04; B29K 2105/26; C08J 2201/026; C08J 2203/04; C08J 2323/08; C08J 2451/06; C08J 2453/02

(57) ABSTRACT

A treatment method for EVA waste materials includes the following steps: step 1: crushing waste EVA shoe soles, waste EVA sheets, and waste EVA trimmings to obtain block-shaped crushed materials with a length of less than 7 cm and a width of less than 5 cm; then, putting the block-shaped crushed materials into a waste crusher to obtain strip-shaped crushed materials; step 2: putting the strip-shaped crushed materials obtained in step 1, Surlyn resin, and PMP into an internal mixer in a weight ratio of 85:(4-10):(4-8), wherein an internal mixing temperature gradually rises, a highest temperature of the internal mixing temperature is 150° C., and an internal mixing time is 18 to 25 minutes, so as to obtain block-shaped mixed materials; and step 3: processing the block-shaped mixed materials, which have been subjected to internal mixing by a screw extruder and an open mill to obtain an EVA recycled film.

### RELATED APPLICATIONS

This application claims priority to International patent application number PCT/CN2022/114521, filed on Aug. 24, 2022, which claims priority to Chinese patent application number 202210048974.1, filed on Jan. 17, 2022. International patent application number PCT/CN2022/114521 and Chinese patent application number 202210048974.1 are incorporated herein by reference.

### FIELD OF THE DISCLOSURE

The present disclosure relates to the technical field of organic polymer compounds, and specifically relates to a foaming material for shoes based on ethylene-vinyl acetate (EVA) waste materials and a treatment method for processing the EVA waste materials.

### BACKGROUND OF THE DISCLOSURE

Ethylene-vinyl acetate copolymer is abbreviated as EVA. EVA typically contains 5%-40% vinyl acetate (VA). Compared to polyethylene (PE), EVA introduces vinyl acetate monomers into its molecular chain, reducing high crystallinity and improving toughness, impact resistance, filler compatibility, and heat sealability. It is widely used in foamed shoe materials, functional greenhouse films, packaging molds, hot melt adhesives, wires and cables, and toys.

Due to its toughness, foamability, and excellent molding properties, EVA is commonly used in mid-to-high-end slippers and soles. An injection molding process is used to make slippers or soles from EVA plastic. In this process, raw materials are heated and melted into a turbulent state by injection equipment, and then the turbulent EVA plastic material is injected into a feed port of the mold by an injection machine. During production, waste materials such as runners and defective products are generated due to process and mold structure reasons. Because of the chemical crosslinking reactions that have already occurred in the EVA material due to its composition and raw material processing techniques, manufacturing companies cannot reuse these waste materials. A small amount of EVA waste ground into powder is sometimes added to low-grade EVA products. Traditionally, these waste materials are either landfilled or incinerated in waste-to-energy plants along with other waste. However, given the market price of the raw materials, recycling these waste materials could still hold considerable value. Simply burying or burning them is a significant waste of resources and warrants further improvement.

### BRIEF SUMMARY OF THE DISCLOSURE

The technical problem to be solved by the present disclosure is to provide a treatment method for EVA waste materials, and another objective is to provide an environmentally friendly foaming material made from EVA recycled film using the aforementioned method.

A technical solution of the present disclosure is as follows.

A treatment method for ethylene-vinyl acetate (EVA) waste materials comprises the following steps.

Step 1: crushing waste EVA shoe soles, waste EVA sheets, waste EVA trimmings, and other waste products to obtain block-shaped crushed materials with a length of less than 7 cm and a width of less than 5 cm. Then, putting the block-shaped crushed materials into a waste crusher to obtain strip-shaped crushed materials.

Step 2: putting the strip-shaped crushed materials obtained in step 1, Surlyn resin, and PMP into an internal mixer in a weight ratio of 85:(4-10):(4-8), wherein an internal mixing temperature gradually rises. A highest temperature of the internal mixing temperature is 150° C., and an internal mixing time is 18 to 25 minutes, so as to obtain block-shaped mixed materials.

Step 3: the block-shaped mixed materials, which have been subjected to mixing, are processed by a screw extruder and an open mill to obtain an EVA recycled film.

The waste crusher comprises a crushing assembly for crushing the EVA waste materials. The crushing assembly comprises a first crushing roller and a second crushing roller opposite to each other, and a crushing channel is formed between the first crushing roller and the second crushing roller for crushing the EVA waste materials. A surface of the first crushing roller is a smooth surface, and a surface of the second crushing roller comprises a plurality of crushing grooves. A roll gap between the first crushing roller and the second crushing roller is less than 3 mm

Furthermore, the plurality of crushing grooves are arranged obliquely on the surface of the second crushing roller, and an inclination angle of each of the plurality of crushing grooves is 10-45°.

Furthermore, the plurality of crushing grooves have outer-large and inner-small structures.

Furthermore, the PMP is fatty acid oligomers.

Furthermore, in the step 3, a base temperature of the screw extruder is 130-150° C.

Furthermore, in the step 3, a specific operation of the open mill comprises performing a film calendering process at a temperature of less than 65° C.

Furthermore, a thickness of the EVA recycled film is less than or equal to 0.02 mm.

A foaming material based on ethylene-vinyl acetate (EVA) waste materials consists of the following ingredients by weight:

| | | |
|---|---|---|
| EVA recycled film | 100 | parts |
| EVA | 0-8 | parts |
| SEBS | 10-15 | parts |
| Blowing agent Azodicarbonamide (AC) | 1.3-1.4 | parts |
| Crosslinking agent | 0.7-0.9 | parts |
| 1,3-Bis(tert-butylperoxyisopropyl)benzene (BIBP) | | |
| Zinc Stearate | 0.3 | parts |
| Stearic acid | 0.4-0.6 | parts |
| Wear-resistant agent | 1.0-1.5 | parts |
| Biodegradation agent | 1.5-2.5 | parts |

Furthermore, a preparation method comprises the following steps: first, after uniformly mixing all the ingredients except for the crosslinking agent BIBP and the blowing agent AC to obtain mixed materials, performing internal mixing; adjusting the internal mixing temperature to be controlled between 86-91° C., and after maintaining for 4 minutes, turning the mixed materials for a first time; when the internal mixing temperature rises to 95° C., turning the mixed materials for a second time; when the internal mixing temperature rises to 101° C., turning the mixed materials for a third time, and adding the crosslinking agent BIBP and the blowing agent AC to the mixed materials; when the internal mixing temperature rises to 107° C., turning the mixed materials for a fourth time; when the internal mixing temperature rises to 112° C., turning the mixed materials for a fifth time, continuing the internal mixing for 1 minute; discharging the mixed materials, and performing open milling and granulation to obtain foaming pellets; and obtaining the foaming material through compression molding and foaming of the foaming pellets.

Furthermore, the biodegradation agent is a polyolefin graft-modified product.

Compared with the existing techniques, the technical solution has the following advantages.

First, the present disclosure achieves the recycling and reuse of EVA shoe sole scraps, defective products, waste, and offcuts by defining specific processing methods for EVA waste materials. This helps alleviate environmental issues caused by white pollution. The EVA recycled film obtained through crushing, internal mixing, and open milling contains less than 20 mg/kg of acetophenone and 2-phenyl-2-propanol, meeting the environmental requirements of Registration, Evaluation, Authorisation and Restriction of Chemicals (REACH) regulations and the “Zero Discharge of Hazardous Chemicals” (ZDHC) standards, and complying with the environmental requirements of international brands.

Second, the inclusion of the sarin resin and PMP with crushed EVA shoe waste in the internal mixing process effectively improves the tackiness and flowability of the crushed EVA shoe waste, significantly enhancing processing performance. The proportion of recycled EVA waste in the shoe sole material can reach up to 79% (by mass), greatly reducing resource waste and improving the utilization rate of waste materials.

Third, by defining the structure and the roll gap of the crushing assembly in the waste crusher, the present disclosure uses shear force to crush bulk materials and expel foaming gases from the foamed EVA, resulting in strip-shaped crushed materials.

Fourth, the second crushing roller comprises the plurality of crushing grooves. Since the EVA waste material is a foamed material with light weight and shallow surface patterns, high-wear-resistant waste EVA soles have a high content of wear-resistant agents and have a smooth surface. If the waste EVA soles are made through single-shot molding, the surface contains a considerable amount of release agent, further smoothing the surface. Therefore, the present disclosure incorporates the plurality of crushing grooves to improve crushing efficiency by feeding the EVA waste materials into the plurality of crushing grooves.

Fifth, PMP is the fatty acid oligomers that can improve dispersion and flowability of rubber material, facilitating better shearing in the internal mixer and better dispersion of the Surlyn resin.

Sixth, the combination of the Surlyn resin with the crushed EVA waste materials enhances the tackiness of the material and blendability due to the high viscosity of resin, ease of crystallization, and good toughness. This also improves the performance of the material during a subsequent lamination process, reducing the likelihood of breakage.

Seventh, extruding the mixed material with the screw extruder after internal mixing ensures more uniform material, increases toughness, and decomposes any residual crosslinking agents while expelling volatile organic compounds.

### BRIEF DESCRIPTION OF THE DRAWINGS

FIG. 1 is a perspective view of a crushing assembly.

FIG. 2 is a side view of a second crushing roller.

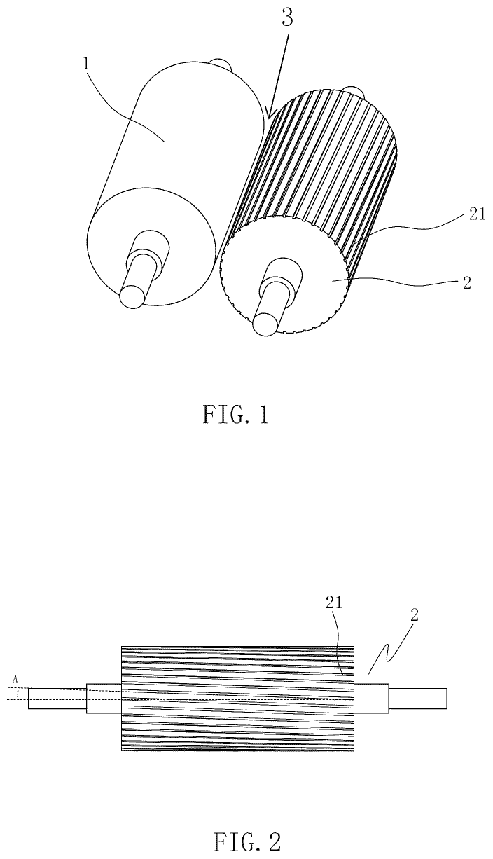

In the figures: 1—first crushing roller, 2—second crushing roller, 21—crushing groove.

### DETAILED DESCRIPTION OF THE EMBODIMENTS

The technical solutions of the present disclosure will be further illustrated and described below through specific embodiments.

A treatment method for ethylene-vinyl acetate (EVA) waste materials comprises the following steps.

Step 1: waste EVA shoe soles, waste EVA sheets, waste EVA trimmings, and other waste products are put into a crusher to be crushed to obtain block-shaped crushed materials with a length of less than 7 cm and a width of less than 5 cm. Then, the block-shaped crushed materials are put into a waste crusher to obtain strip-shaped crushed materials.

Step 2: the strip-shaped crushed materials obtained in step 1, Surlyn resin, and PMP (i.e., a plasticizer, KETTLITZ-Mediaplast PMP) are put into an internal mixer in a weight ratio of 85:(4-10):(4-8), wherein an internal mixing temperature gradually rises. A highest temperature of the internal mixing temperature is 150° C., and an internal mixing time is 18 to 25 minutes, so as to obtain block-shaped mixed materials.

Step 3: the block-shaped mixed materials, which have been subjected to internal mixing, are processed by a screw extruder and an open mill to obtain an EVA recycled film.

The waste crusher comprises a crushing assembly for crushing EVA waste materials. The crushing assembly comprises a first crushing roller and a second crushing roller opposite to each other, and a crushing channel 3 is formed between the first crushing roller and the second crushing roller for crushing the EVA waste materials. A surface of the first crushing roller is a smooth surface, and a surface of the second crushing roller comprises a plurality of crushing grooves 21. A roll gap between the first crushing roller and the second crushing roller is less than 3 mm. The plurality of crushing grooves 21 are arranged obliquely on the surface of the second crushing roller. An inclination angle of each of the plurality of crushing grooves 21 is 10-45°, and preferably, the inclination angle is 30°. Specifically, the plurality of crushing grooves 21 have outer-large and inner-small structures along a radial direction of the second crushing roller (i.e., a cross-section of each of the plurality of crushing grooves 21 is trapezoidal). A gap between two adjacent crushing grooves 21 of the plurality of crushing grooves 21 is 3-50 mm, a width of each of the plurality of crushing grooves 21 is 1-4 mm, and a depth of each of the plurality of crushing grooves 21 is 0.3-3 mm. The cross-section of each of the plurality of crushing grooves 21 is trapezoidal with a short side of 0.1-0.8 mm. Further, the waste crusher comprises an exhaust gas collection device with a high power to collect volatile organic compounds such as ammonia, acetophenone, 2-Phenyl-2-propanol (2P-2P), dicarbonamide, and other volatile organic compounds volatilized during a crushing process.

A thickness of the EVA recycled film is less than or equal to 0.02 mm, and the PMP is fatty acid oligomers.

In step 1, when the strip-shaped crushed materials come out, the strip-shaped crushed materials are spread out on ground, dispersed, and not piled up, which facilitates heat dissipation and air dispersal.

In step 2, a chamber of the internal mixer is airtight. During an operation of the internal mixer, the chamber is under negative pressure, and all sides of the chamber are disposed with suction pipes to enable the volatile organic compounds to be pumped away by an air collection device through the suction pipes.

In step 3, a base temperature of the screw extruder is 130-150° C. Materials poured out of the internal mixer will still be a little loose, and through the screw extruder, the materials can be more uniform, which can improve toughness of the materials, decompose residual cross-linking agent, and discharge the volatile organic compounds.

A specific operation of the open mill comprises performing a film calendering process at a temperature of less than 65° C.

An environmentally friendly foaming material based on the EVA waste materials consists of the following ingredients by weight:

| | | |
|---|---|---|
| EVA recycled film | 100 | parts |
| EVA | 0-8 | parts |
| Styrene Ethylene Butylene Styrene (SEBS) | 10-15 | parts |
| Blowing agent Azodicarbonamide (AC)) | 1.3-1.4 | parts |
| Crosslinking agent | 0.7-0.9 | parts |
| 1,3-Bis(tert-butylperoxyisopropyl)benzene (BIBP) | | |
| Zinc Stearate | 0.3 | parts |
| Stearic acid | 0.4-0.6 | parts |
| Wear-resistant agent | 1.0-1.5 | parts |
| Biodegradation agent | 1.5-2.5 | parts |

A preparation method comprises the following steps: first, after uniformly mixing all the raw materials except for the crosslinking agent BIBP and the blowing agent AC to obtain mixed materials, performing internal mixing; adjusting the internal mixing temperature to be controlled between 86-91° C., and after maintaining for 4 minutes, turning the mixed materials for a first time; when the internal mixing temperature rises to 95° C., turning the mixed materials for a second time; when the internal mixing temperature rises to 101° C., turning the mixed materials for a third time, and adding the crosslinking agent BIBP and the blowing agent AC to the mixed materials; when the internal mixing temperature rises to 107° C., turning the mixed materials for a fourth time; when the internal mixing temperature rises to 112° C., turning the mixed materials for a fifth time, continuing the internal mixing for 1 minute; discharging the mixed materials, and performing open milling and granulation to obtain environmentally friendly foaming pellets; and obtaining the environmentally friendly foaming material through compression molding and foaming of the environmentally friendly foaming pellets.

SEBS is in a form of oil-free granules with excellent toughening effect.

The biodegradation agent is polyolefin graft-modified products. The biodegradation agent can accelerate a degradation rate of polymers in anaerobic environments, and rubber shoe soles can achieve at least 90% degradation after 90 days in an anaerobic landfill. Specifically, the biodegradation agent is made by injecting anaerobic organic additives into polyolefin materials. In landfills and deep-sea environments filled with active anaerobic organisms, the biodegradation agent attracts natural microorganisms and produces enzymes that break down a polymer structure of the rubber. The microorganisms obtain the energy that the microorganisms need by digesting the rubber, which accelerates reproduction rates of the microorganisms and enhances the biodegradation rate, ultimately converting the rubber products back into organic humus.

### Embodiment 1

A treatment method for EVA waste materials comprises the following steps.

Step 1: waste EVA shoe soles, waste EVA sheets, waste EVA trimmings, and other waste products are put into a crusher to be crushed to obtain block-shaped crushed materials with a length of less than 7 cm and a width of less than 5 cm. Then, the block-shaped crushed materials are put into a waste crusher to obtain strip-shaped crushed materials.

Step 2: the strip-shaped crushed materials obtained in step 1, Surlyn resin, and PMP are put into a closed plastic mixer in a weight ratio of 85:4:8, wherein an internal mixing temperature gradually rises. A highest temperature of the internal mixing temperature is 150° C., and an internal mixing time is 18 minutes, so as to obtain block-shaped mixed materials.

Step 3: the block-shaped mixed materials, which have been subjected to internal mixing, are processed by a screw extruder and an open mill to obtain an EVA recycled film.

The waste crusher comprises a crushing assembly for crushing EVA waste materials. The crushing assembly comprises a first crushing roller and a second crushing roller opposite to each other, and a crushing channel 3 is formed between the first crushing roller and the second crushing roller for crushing the EVA waste materials. A surface of the first crushing roller is a smooth surface, and a surface of the second crushing roller comprises a plurality of crushing grooves 21. A roll gap (i.e., a width of the crushing channel 3) between the first crushing roller and the second crushing roller is 1.5-2 mm. Specifically, the plurality of crushing grooves 21 are arranged obliquely on the surface of the second crushing roller, and an inclination angle A of each of the plurality of crushing grooves 21 is 15°. Furthermore, the plurality of crushing grooves 21 have outer-large and inner-small structures. A gap between two adjacent crushing grooves 21 of the plurality of crushing grooves 21 is 12 mm, a width of each of the plurality of crushing grooves 21 is 2 mm, and a depth of each of the plurality of crushing grooves 21 is 1.5 mm. A cross-section of each of the plurality of crushing grooves 21 is trapezoidal with a short side of 0.5 mm.

A thickness of the EVA recycled film is equal to 0.02 mm, and the PMP is fatty acid oligomers.

In step 3, a base temperature of the screw extruder is 130° C. A specific operation of the open mill comprises performing a film calendering process at a temperature of less than 65° C.

An environmentally friendly foaming material based on the EVA waste materials consists of the following ingredients by weight:

| | | |
|---|---|---|
| EVA recycled film | 100 | parts |
| SEBS | 15 | parts |
| Blowing agent AC | 1.3 | parts |
| Crosslinking agent BIBP | 0.9 | parts |
| Zinc Stearate | 0.3 | parts |
| Stearic acid | 0.6 | parts |
| Wear-resistant agent | 1.0 | parts |
| Biodegradation agent | 2.5 | parts |

A preparation method comprises the following steps: first, after uniformly mixing all the raw materials except for the crosslinking agent BIBP and the blowing agent AC to obtain mixed materials, performing internal mixing; adjusting the internal mixing temperature to be controlled between 86-91° C., and after maintaining for 4 minutes, turning the mixed materials for a first time; when the internal mixing temperature rises to 95° C., turning the mixed materials for a second time; when the internal mixing temperature rises to 101° C., turning the mixed materials for a third time, and adding the crosslinking agent BIBP and the blowing agent AC to the mixed materials; when the internal mixing temperature rises to 107° C., turning the mixed materials for a fourth time; when the internal mixing temperature rises to 112° C., turning the mixed materials for a fifth time, continuing the internal mixing for 1 minute; discharging the mixed materials, and performing open milling and granulation to obtain environmentally friendly foaming pellets; and obtaining the environmentally friendly foaming material through compression molding and foaming of the environmentally friendly foaming pellets.

The environmentally friendly foaming material can achieve a 92% degradation (by mass) after 90 days in an anaerobic landfill. The degradation experiment refers to GB/T 33797, and a mass loss is calculated after 90 days in the anaerobic landfill.

### Embodiment 2

A treatment method for EVA waste materials comprises the following steps.

Step 1: waste EVA shoe soles, waste EVA sheets, waste EVA trimmings, and other waste products are put into a crusher to be crushed to obtain block-shaped crushed materials with a length of less than 7 cm and a width of less than 5 cm. Then, the block-shaped crushed materials are put into a waste crusher to obtain strip-shaped crushed materials.

Step 2: the strip-shaped crushed materials obtained in step 1, Surlyn resin, and PMP are put into a closed plastic mixer in a weight ratio of 85:10:4, wherein an internal mixing temperature gradually rises. A highest temperature of the internal mixing temperature is 150° C., and an internal mixing time is 25 minutes, so as to obtain block-shaped mixed materials;

Step 3: the block-shaped mixed materials, which have been subjected to internal mixing, are processed by a screw extruder and an open mill to obtain an EVA recycled film.

The waste crusher comprises a crushing assembly for crushing EVA waste materials. The crushing assembly comprises a first crushing roller and a second crushing roller opposite to each other, and a crushing channel 3 is formed between the first crushing roller and the second crushing roller for crushing the EVA waste materials. A surface of the first crushing roller is a smooth surface, and a surface of the second crushing roller comprises a plurality of crushing grooves 21. A roll gap between the first crushing roller and the second crushing roller is 1.5-2 mm. Specifically, the plurality of crushing grooves 21 are arranged obliquely on the surface of the second crushing roller, and an inclination angle A of each of the plurality of crushing grooves 21 is 15°. Furthermore, the plurality of crushing grooves 21 have outer-large and inner-small structures. A gap between two adjacent crushing grooves 21 of the plurality of crushing grooves 21 is 30 mm, a width of each of the plurality of crushing grooves 21 is 3 mm, and a depth of each of the plurality of crushing grooves 21 is 3 mm. A cross-section of each of the plurality of crushing grooves 21 is trapezoidal with a short side of 0.8 mm.

A thickness of the EVA recycled film is equal to 0.01 mm, and the PMP is fatty acid oligomers.

In step 3, a base temperature of the screw extruder is 150° C. A specific operation of the open mill comprises performing a film calendering process at a temperature of less than 65° C.

An environmentally friendly foaming material based on the EVA waste materials consists of the following ingredients by weight:

| | | |
|---|---|---|
| EVA recycled film | 100 | parts |
| EVA | 8 | parts |
| SEBS | 10 | parts |
| Blowing agent AC | 1.4 | parts |
| Crosslinking agent BIBP | 0.7 | parts |
| Zinc Stearate | 0.3 | parts |
| Stearic acid | 0.4 | parts |
| Wear-resistant agent | 1.5 | parts |
| Biodegradation agent | 1.5 | parts |

A preparation method comprises the following steps: first, after uniformly mixing all the raw materials except for the crosslinking agent BIBP and the blowing agent AC to obtain mixed materials, performing internal mixing; adjusting the internal mixing temperature to be controlled between 86-91° C., and after maintaining for 4 minutes, turning the mixed materials for a first time; when the internal mixing temperature rises to 95° C., turning the mixed materials for a second time; when the internal mixing temperature rises to 101° C., turning the mixed materials for a third time, and adding the crosslinking agent BIBP and the blowing agent AC to the mixed materials; when the internal mixing temperature rises to 107° C., turning the mixed materials for a fourth time; when the internal mixing temperature rises to 112° C., turning the mixed materials for a fifth time, continuing the internal mixing for 1 minute; discharging the mixed materials, and performing open milling and granulation to obtain environmentally friendly foaming pellets; and obtaining the environmentally friendly foaming material through compression molding and foaming of the environmentally friendly foaming pellets.

The environmentally friendly foaming material can achieve a 85% degradation (by mass) after 90 days in an anaerobic landfill. The degradation experiment refers to GB/T 33797, and a mass loss is calculated after 90 days in the anaerobic landfill.

### Embodiment 3

A treatment method for EVA waste materials comprises the following steps.

Step 1: waste EVA shoe soles, waste EVA sheets, waste EVA trimmings, and other waste products are put into a crusher to be crushed to obtain block-shaped crushed materials with a length of less than 7 cm and a width of less than 5 cm. Then, the block-shaped crushed materials are put into a waste crusher to obtain strip-shaped crushed materials.

Step 2: the strip-shaped crushed materials obtained in step 1, Surlyn resin, and PMP are put into a closed plastic mixer in a weight ratio of 85:7:6, wherein an internal mixing temperature gradually rises. A highest temperature of the internal mixing temperature is 150° C., and an internal mixing time is 21 minutes, so as to obtain block-shaped mixed materials.

Step 3: the block-shaped mixed materials, which have been subjected to internal mixing, are processed by a screw extruder and an open mill to obtain an EVA recycled film.

The waste crusher comprises a crushing assembly for crushing EVA waste materials. The crushing assembly comprises a first crushing roller and a second crushing roller opposite to each other, and a crushing channel 3 is formed between the first crushing roller and the second crushing roller for crushing the EVA waste materials. A surface of the first crushing roller is a smooth surface, and a surface of the second crushing roller comprises a plurality of crushing grooves 21. A roll gap between the first crushing roller and the second crushing roller is less than 3 mm. Specifically, the plurality of crushing grooves 21 are arranged obliquely on the surface of the second crushing roller, and an inclination angle A of each of the plurality of crushing grooves 21 is 15°. Furthermore, the plurality of crushing grooves 21 have outer-large and inner-small structures. A gap between two adjacent crushing grooves 21 of the plurality of crushing grooves 21 is 8 mm, a width of each of the plurality of crushing grooves 21 is 1 mm, and a depth of each of the plurality of crushing grooves 21 is 0.3 mm. A cross-section of each of the plurality of crushing grooves 21 is trapezoidal with a short side of 0.1 mm.

A thickness of the EVA recycled film is equal to 0.008 mm, and the PMP is fatty acid oligomers.

In step 3, a base temperature of the screw extruder is 140° C. A specific operation of the open mill comprises performing a film calendering process at a temperature of less than 65° C.

An environmentally friendly foaming material based on the EVA waste materials consists of the following ingredients by weight:

| | | |
|---|---|---|
| EVA recycled film | 100 | parts |
| EVA | 5 | parts |
| SEBS | 12 | parts |
| Blowing agent AC | 1.35 | parts |
| Crosslinking agent BIBP | 0.8 | parts |
| Zinc Stearate | 0.3 | parts |
| Stearic acid | 0.5 | parts |
| Wear-resistant agent | 1.2 | parts |
| Biodegradation agent | 2.0 | parts |

A preparation method comprises the following steps: first, after uniformly mixing all the raw materials except for the crosslinking agent BIBP and the blowing agent AC to obtain mixed materials, performing internal mixing; adjusting the internal mixing temperature to be controlled between 86-91° C., and after maintaining for 4 minutes, turning the mixed materials for a first time; when the internal mixing temperature rises to 95° C., turning the mixed materials for a second time; when the internal mixing temperature rises to 101° C., turning the mixed materials for a third time, and adding the crosslinking agent BIBP and the blowing agent AC to the mixed materials; when the internal mixing temperature rises to 107° C., turning the mixed materials for a fourth time; when the internal mixing temperature rises to 112° C., turning the mixed materials for a fifth time, continuing the internal mixing for 1 minute; discharging the mixed materials, and performing open milling and granulation to obtain environmentally friendly foaming pellets; and obtaining the environmentally friendly foaming material through compression molding and foaming of the environmentally friendly foaming pellets.

The environmentally friendly foaming material can achieve a 94% degradation (by mass) after 90 days in an anaerobic landfill. The degradation experiment refers to GB/T 33797, and a mass loss is calculated after 90 days in the anaerobic landfill.

### COMPARATIVE EXAMPLE 1

Raw material composition and a preparation method of comparative Example 1 are basically the same as that of Embodiment 3, with the difference that the preparation of EVA recycled film only comprises the crushing treatment in Step 1; and the raw material composition of the environmentally friendly foaming material does not include SEBS.

The following data is obtained by testing Embodiment 1 to Embodiment 3 and Comparative Example 1 accordingly:

A compression set test refers to HG/T 2876 (temperature 50° C., time 6 hours, compression ratio 50%). A rebound rate test uses a GT-7042-VAA vertical elasticity tester. Acetophenone content and 2-phenyl-2-propanol content are analyzed by Gas Chromatography-Mass Spectrometry (GCMS) after being extracted with acetone, following 24 hours of room temperature (e.g., 20-25° C.). exposure of the soles (detection limit 2 mg/kg).

| | | | | Comparative | Comparative |
|---|---|---|---|---|---|
| Project | EMBODIMENT 1 | EMBODIMENT 2 | EMBODIMENT 3 | Example 1 | Example 2 |
| Compression | 39 | 32 | 35 | 64 | 82 |
| set rate | | | | | |
| Rebound rate | 48 | 51 | 56 | 39 | 38 |
| Acetophenone | 11 | 7 | 10 | 513 | 881 |
| content | | | | | |
| (mg/kg) | | | | | |
| 2-phenyl-2- | 17 | 4 | 6 | 611 | 1098 |
| propanol content | | | | | |
| (mg/kg) | | | | | |

From the above table, it can be seen that the environmentally friendly foaming material prepared in the present disclosure has a low compression set rate and high resilience, meeting the requirements for shoe soles. Additionally, the acetophenone and 2-phenyl-2-propanol content in the EVA recycled film obtained through crushing, internal mixing, and open milling are both less than 20 mg/kg, complying with Registration, Evaluation, Authorisation and Restriction of Chemicals (REACH) regulations and the “Zero Discharge of Hazardous Chemicals” (ZDHC) environmental standards, thus meeting the environmental requirements of international brands.

The above are only preferred embodiments of the present disclosure, and therefore cannot be used to limit the scope of the present disclosure. That is, equivalent changes and modifications made based on the patent scope of the present disclosure and the content of the specification should still fall within the scope of the present disclosure.

What is claimed is:

1. A treatment method for ethylene-vinyl acetate (EVA) waste materials comprising the following steps:
step 1: crushing waste EVA shoe soles, waste EVA sheets, waste EVA trimmings, and other waste products to obtain block-shaped crushed materials with a length of less than 7 cm and a width of less than 5 cm; then, putting the block-shaped crushed materials into a waste crusher to obtain strip-shaped crushed materials;
step 2: putting the strip-shaped crushed materials obtained in step 1, Surlyn resin, and PMP into an internal mixer in a weight ratio of 85:(4-10):(4-8), wherein an internal mixing temperature gradually rises, a highest temperature of the internal mixing temperature is 150° C., and an internal mixing time is 18 to 25 minutes, so as to obtain block-shaped mixed materials; and
step 3: processing the block-shaped mixed materials, which have been subjected to internal mixing by a screw extruder and an open mill to obtain an EVA recycled film, wherein:
the waste crusher comprises a crushing assembly for crushing EVA waste materials,
the crushing assembly comprises a first crushing roller and a second crushing roller opposite to each other,
a crushing channel is formed between the first crushing roller and the second crushing roller for crushing the EVA waste materials,
a surface of the first crushing roller is a smooth surface,
a surface of the second crushing roller comprises a plurality of crushing grooves, and
a roll gap between the first crushing roller and the second crushing roller is less than 3 mm.

2. The treatment method for the EVA waste materials according to claim 1, wherein:
the plurality of crushing grooves are arranged obliquely on the surface of the second crushing roller, and
an inclination angle of each of the plurality of crushing grooves is 10-45°.

3. The treatment method for the EVA waste materials according to claim 1, wherein:
the plurality of crushing grooves have outer-large and inner-small structures.

4. The treatment method for the EVA waste materials according to claim 1, wherein:
the PMP is fatty acid oligomers.

5. The treatment method for the EVA waste materials according to claim 1, wherein:
in the step 3, a base temperature of the screw extruder is 130-150° C.

6. The treatment method for the EVA waste materials according to claim 1, wherein:
in the step 3, a specific operation of the open mill comprises performing a film calendering process at a temperature of less than 65° C.

7. The treatment method for the EVA waste materials according to claim 6, wherein:
a thickness of the EVA recycled film is less than or equal to 0.02 mm.

8. A foaming material based on ethylene-vinyl acetate (EVA) waste materials consisting of the following ingredients by weight:

| | | |
|---|---|---|
| EVA recycled film | 100 | parts |
| EVA | 0-8 | parts |
| Styrene Ethylene Butylene Styrene | 10-15 | parts |
| (SEBS) | | |
| Blowing agent Azodicarbonamide (AC) | 1.3-1.4 | parts |
| Crosslinking agent | 0.7-0.9 | parts |
| 1,3-Bis(tert-butylperoxyisopropyl)benzene (BIBP) | | |
| Zinc Stearate | 0.3 | parts |
| Stearic acid | 0.4-0.6 | parts |
| Wear-resistant agent | 1.0-1.5 | parts |
| Biodegradation agent | 1.5-2.5 | parts. |

9. The foaming material based on the EVA waste materials according to claim 8, wherein:
a preparation method comprises the following steps:
first, after uniformly mixing all the ingredients except for the crosslinking agent BIBP and the blowing agent AC to obtain mixed materials, performing internal mixing;
adjusting an internal mixing temperature to be controlled between 86-91° C., and after maintaining for 4 minutes, turning the mixed materials for a first time;
when the internal mixing temperature rises to 95° C., turning the mixed materials for a second time;
when the internal mixing temperature rises to 101° C., turning the mixed materials for a third time, and adding the crosslinking agent BIBP and the blowing agent AC to the mixed materials;
when the internal mixing temperature rises to 107° C., turning the mixed materials for a fourth time;
when the internal mixing temperature rises to 112° C., turning the mixed materials for a fifth time, continuing the internal mixing for 1 minute;
discharging the mixed materials, and performing open milling and granulation to obtain foaming pellets; and
obtaining the foaming material through compression molding and foaming of the foaming pellets.

10. The foaming material based on the EVA waste materials according to claim 8, wherein:
the biodegradation agent is a polyolefin graft-modified product.
